(19) United States
(12) Patent Application Publication
(10) Pub. No.: US 2024/0220097 A1
(43) Pub. Date: Jul. 4, 2024

(54) VIRTUAL MOUSE WITH TACTILE FEEDBACK PROVIDED VIA KEYBOARD KEYS

(71) Applicant: QUALCOMM Incorporated, San Diego, CA (US)

(72) Inventors: Siddhant Sanjay SHIRGUPPE, Belgaum (IN); Nikhil Kumar GUPTA, Bengaluru (IN)

(21) Appl. No.: 18/148,162

(22) Filed: Dec. 29, 2022

(51) Int. Cl. G06F 3/0487; G06F 3/01; G06F 3/04812; G06F 9/451

(52) U.S. Cl. CPC G06F 3/0487; G06F 3/017; G06F 3/04812; G06F 9/453

(57) ABSTRACT

Various embodiments include methods for receiving user inputs to a computing device via a virtual mouse function. Methods may include tracking movements of a user's hand, moving a cursor of a virtual mouse in a graphical user interface (GUI) responsive to hand movements, predicting a target user interface element for the cursor in the GUI, and adjusting a speed of the cursor in the GUI based on a distance to the predicted target user interface element so that fingers of the user's hand will be on or over particular keys on the physical keyboard when the cursor is on the predicted target user interface element. Methods may further include switching from a normal operating mode to the virtual mouse operating mode in response to recognizing a user gesture. In the virtual mouse operating mode, key presses on the physical keyboard are translated into mouse click inputs.

### BACKGROUND

Extended reality is a growing technology and entertainment field that present an alternate or overlay to reality via a user interface. Virtual reality (VR) and augmented reality (AR) require new input methods that better fit the user experience in these realities where a portion of the user's real-world view is obstructed. Devices that encompass VR, AR and/or mixed reality (MR) technologies are sometimes referred to as extended reality (XR) devices. In addition, even in a virtual world, humans may expect or prefer other feedback to their senses besides visual feedback. Thus far, however, user interfaces for VR and AR remain confusing for users and require steep learning curves.

### SUMMARY

Various aspects include systems and methods performed by a computing device. Various aspects may include receiving tracking information corresponding to movement of a hand of a user while operating in a virtual mouse operating mode; generating one or more instructions to move a cursor of the virtual mouse in a graphical user interface (GUI) based on the tracking information; predicting a target user interface element for the cursor in the GUI; and adjusting a speed or acceleration of the cursor based on a distance to the predicted target user interface element so that two fingers of the hand of the user will be on or over two keys on the physical keyboard when the cursor is on the predicted target user interface element.

Some aspects may further include receiving an indication of a user gesture corresponding to a request for a virtual mouse; switching from a normal operating mode to the virtual mouse operating mode in response to receiving the indication of the user gesture, the virtual mouse operating mode configured to translate one or more key presses of a physical keyboard into mouse clicks of the virtual mouse. Some aspects may further include selecting a pair of keys on the physical keyboard at a corresponding distance from a position of the virtual mouse based on the tracking information and the predicted target user interface element, in which adjusting the speed or acceleration of the cursor is based on the distance to the predicted target user interface element and the corresponding distance between the pair of keys and the position of the virtual mouse so that two fingers of the hand of the user will be on or over the selected pair of keys on the physical keyboard when the cursor is on the predicted target user interface element.

In some aspects, in the virtual mouse operating mode, the one or more key presses of the physical keyboard is translated from a hardware key code of the physical keyboard into the mouse clicks at the computing device.

In some aspects, predicting the target user interface element may further include receiving GUI information including one or more positions of clickable elements displayed in the GUI; calculating a vector for the cursor based on the tracking information; and identifying the predicted target user interface element based on the vector and the one or more positions of the clickable elements.

In some aspects, movement of the cursor may be confined to movement of the hand of the user over the physical keyboard. Some aspects may further include mapping positions in a first area of the physical keyboard and a second area of the GUI so that the tracking information of the movement of the hand of the user over the first area relates to movement of the cursor in the GUI.

In some aspects one of a smart glove, a camera, or a user headset provides the tracking information, in which the tracking information relates to hand movements of the user in a predefined physical space.

Some aspects may further include training a virtual mouse process to obtain the tracking information of a particular user in a training session by: generating one or more icon shapes in the GUI for the particular user to click; receiving tracking information corresponding to movement of a hand of the particular user; generating one or more instructions to move a cursor of the virtual mouse in a GUI based on the tracking information; predicting one of the icon shapes that the particular user is likely to click on in the GUI; adjusting the speed or acceleration of the cursor based on a distance to the predicted one of the icon shapes so that two fingers of the hand of the user will be on or over two selected keys on the physical keyboard when the cursor is on the predicted target user interface element; receiving key press information resulting from the particular user pressing two or more keys; and adjusting a parameter used in adjusting the speed or acceleration of the cursor in response to the received key press information indicating that the particular user pressed one or more keys different from the two selected keys on the physical keyboard.

Further aspects include an XR device having a processor configured to perform one or more operations of any of the methods summarized above. Further aspects include processing devices for use in an XR device configured with processor-executable instructions to perform operations of any of the methods summarized above. Further aspects include a non-transitory processor-readable storage medium having stored thereon processor-executable instructions configured to cause a processor of a XR device to perform operations of any of the methods summarized above. Further aspects include an XR device having means for performing functions of any of the methods summarized above. Further aspects include a system on chip for use in an XR device and that includes a processor configured to perform one or more operations of any of the methods summarized above.

### BRIEF DESCRIPTION OF THE DRAWINGS

The accompanying drawings, which are incorporated herein and constitute part of this specification, illustrate example embodiments of various embodiments, and together with the general description given above and the detailed description given below, serve to explain the features of the claims.

FIG. 1A is a system diagram illustrating an example system suitable for implementing various embodiments.

FIG. 1B is a system diagram illustrating an example system architecture suitable for implementing various embodiments.

FIG. 2 is an illustration of an example system including a user interface according to various embodiments.

FIG. 3 is a system block diagram illustrating an example system suitable for implementing various embodiments.

FIG. 4 is a system block diagram illustrating an example system suitable for implementing various embodiments.

FIG. 5 is an illustration of an example user interface training system suitable for implementing various embodiments.

FIG. 6 is a flow diagram illustrating an example method for controlling cursor movement according to various embodiments.

FIG. 7 is a flow diagram illustrating an example method of click processing according to some embodiments.

FIG. 8 is a flow diagram illustrating an example process suitable according to some embodiments.

FIG. 9 is a component block diagram of an example of a computing device suitable for implementing various embodiments.

FIG. 10 is a system diagram illustrating a device and components suitable for implementing various embodiments.

FIG. 11 is a system diagram illustrating a device and components suitable for implementing various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes and are not intended to limit the scope of the claims.

Various embodiments include methods and computing device implementing such methods or providing virtual mouse functionality that transforms functions of one or more keys of a keyboard to provide tactile feedback similar to a physical mouse. In various embodiments, the virtual mouse may function to present a cursor in a graphical user interface (GUI) display with the position of the cursor in the GUI corresponding to the position of the user's hand moving as if manipulating a physical mouse. In various embodiments the cursor may be rendered in the GUI display presented on a variety of display devices, including for example a VR, AR, MR or XR wearable display device, a computer monitor, and/or a laptop computer screen. To enable a user's finger or fingers to be positioned over particular keyboard keys configured to receive a mouse click input, various embodiments adjust the movements of the cursor in the GUI so that cursor arrives on or over a GUI icon when the user's finger or fingers stop moving and are positioned over keyboard key or keys. In this manner, when the user depresses a finger to execute a mouse click, the user's finger or finger contacts and depresses a single key (avoiding a multiple key press) that the computing device has configured to interpret as a mouse click input rather than the input normally assigned to the key.

To achieve this functionality, the computing device may include or be connected to a sensor (e.g., a camera) configured to track the movement of the user's hand. Using this sensor input (e.g., camera images), various embodiments may include receiving tracking information corresponding to movement of the hand of the user while the computer is executing virtual mouse functionality of various embodiments. Based on this tracking information, the computing device may generate instructions to move the cursor of the virtual mouse in GUI, thus appearing to follow movements of the user's hand. The computing device may process movements of the user's hand, and thus the cursor, in the context of actionable icons (i.e., an image object that is associated with an action or function when “clicked on” by a mouse button press) displayed on the GUI to identify or predict one of the GUI icons that the user is going to click on. This predicted icon is referred to herein as a “target user interface element.” Then to ensure that the user's finger (or fingers) is positioned over a particular key, the computing device may adjust the speed or acceleration of cursor movements in the GUI based on a distance to the predicted target user interface element. Such adjustments may be performed continuously until the user's hand stops moving. In this manner, one, two or more fingers of the hand of the user will be on or over one, two or more keys on the physical keyboard when the cursor is positioned in the GUI on the predicted target user interface element. Thus, when the user actuates a mouse click movement with one finger, the user will press one key, thereby providing tactile feedback of the mouse click while providing confirmation of the user's input.

A computing device, including VR/AR/MR/XR systems, may be configured in software to implement operating modes in which user inputs are received via different input mechanisms, including keyboards, physical mouse, and a virtual mouse according to various embodiments. As used herein, the term normal keyboard operating mode refers to an operating configuration in which the computing device may receive user inputs responsive to user key presses on a physical keyboard. As used herein, the virtual mouse operating mode refers to an operating configuration in which the computing device executes the virtual mouse functionality of various embodiments and may receive user mouse button inputs responsive to key presses of particular keys in the physical keyboard. In some embodiments, the computing device may be configured to switch from the normal keyboard operating mode to the virtual mouse operating mode in response to recognizing a particular user input indication, such as a user gesture that has been preconfigured to correspond to a request to activate a virtual mouse. While in the virtual mouse operating mode, the computing device may be configured to translate selected one or more key presses of a physical keyboard into mouse clicks of the virtual mouse.

Some embodiments may include a training routine that may be implemented in the computing device to enable the user to learn how to use the virtual mouse while enabling the computing device to learn, via machine learning methods, parameters for correlating user hand movements to cursor movements in the GUI and predict a target user interface element based on user hand movements.

The term “user equipment” (UE) is used herein to refer to any one or all of wireless communication devices, wireless appliances, cellular telephones, smartphones, portable computing devices, personal or mobile multi-media players, laptop computers, tablet computers, smartbooks, ultrabooks, palmtop computers, wireless electronic mail receivers, virtual reality displays, extended reality displays, multimedia Internet-enabled cellular telephones, wireless router devices, medical devices and equipment, biometric sensors/devices, wearable devices including smart watches, smart clothing, smart glasses, smart wrist bands, smart jewelry (for example, smart rings and smart bracelets), entertainment devices (for example, wireless gaming controllers, music and video players, satellite radios, etc.), wireless-network enabled Internet of Things (IoT) devices including smart meters/sensors, industrial manufacturing equipment, large and small machinery and appliances for home or enterprise use, wireless communication elements within vehicles, wireless devices affixed to or incorporated into various mobile platforms, global positioning system devices, and similar electronic devices that include a memory, wireless communication components and a programmable processor.

The term “system on chip” (SOC) is used herein to refer to a single integrated circuit (IC) chip that contains multiple resources or processors integrated on a single substrate. A single SOC may contain circuitry for digital, analog, mixed-signal, and radio-frequency functions. A single SOC also may include any number of general purpose or specialized processors (digital signal processors, modem processors, video processors, etc.), memory blocks (such as ROM, RAM, Flash, etc.), and resources (such as timers, voltage regulators, oscillators, etc.). SOCs also may include software for controlling the integrated resources and processors, as well as for controlling peripheral devices.

The term “system in a package” (SIP) may be used herein to refer to a single module or package that contains multiple resources, computational units, cores or processors on two or more IC chips, substrates, or SOCs. For example, a SIP may include a single substrate on which multiple IC chips or semiconductor dies are stacked in a vertical configuration. Similarly, the SIP may include one or more multi-chip modules (MCMs) on which multiple ICs or semiconductor dies are packaged into a unifying substrate. A SIP also may include multiple independent SOCs coupled together via high-speed communication circuitry and packaged in close proximity, such as on a single motherboard or in a single wireless device. The proximity of the SOCs facilitates high speed communications and the sharing of memory and resources.

As used herein, the terms “network,” “system,” “wireless network,” “cellular network,” and “wireless communication network” may interchangeably refer to a portion or all of a wireless network of a carrier associated with a wireless device and/or subscription on a wireless device. The techniques described herein may be used for various wireless communication networks, such as Code Division Multiple Access (CDMA), time division multiple access (TDMA), FDMA, orthogonal FDMA (OFDMA), single carrier FDMA (SC-FDMA), frequency-hopping, spread spectrum, and other networks. In general, any number of wireless networks may be deployed in a given geographic area. Each wireless network may support at least one radio access technology, which may operate on one or more frequency or range of frequencies. In another example, an OFDMA network may implement Evolved UTRA (E-UTRA) (including LTE standards), Institute of Electrical and Electronics Engineers (IEEE) 802.11 (Wi-Fi), IEEE 802.16 (WiMAX), IEEE 802.20, Flash-OFDM®, etc. In another example, a frequency-hopping spread-spectrum network may implement Bluetooth (Bluetooth Special Interest Group) 5.0 and its variants, predecessors, and successors.

Augmented reality (AR), virtual reality (VR), mixed reality (MR) and extended reality (XR), which refers to all of AR, VR and MR technologies, promise to be the next frontier of media by adding, extending, or overlaying additional features into the real world we sense around us. VR/AR/MR/XR media may primarily be audiovisual and include textual overlays but in many XR system configurations the user interface requires physical input. In some implementations, a portable user device providing an extended reality experience may be VR/AR/MR/XR glasses or goggles that include a display positioned in front of the user's eyes so as to overlay images and information over the real world. For example, Being positioned in front of the wearer's eyes, XR glasses and goggles can make seeing a physical mouse difficult, which is why various embodiments may be particularly useful in VR/AR/MR/XR applications, although the GUI display including a virtual mouse may also be presented on a monitor, laptop display or other non-wearable display. VR/AR/MR/XR glasses or goggles are wearable and the term “wearable device” is used herein to refer generally to devices implementing various embodiments. Further, the term “XR wearable device” will be used in the following descriptions as a representative example of wearable devices for viewing VR/AR/MR/XR media and is intended to encompass AR glasses, XR glasses, AR goggles, XR goggles, VR goggles, MR glasses, MR goggles and similar wearable devices.

In some implementations, VR/AR/MR/XR viewing devices, such as XR wearable devices, work in conjunction with a bridge communication device (referred to herein as an “bridge device”), such as a smartphone, tablet computer, personal computer, which are referred to herein as user equipment (UE). In such implementations, the bridge device or UE may serve as a communication hub for receiving VR/AR/MR/XR media from a remote server or edge server, such as via a 5G communication link, and relaying the media data to the XR wearable device via a local wireless communication link, such as Wi-Fi or Bluetooth. Similarly, the bridge device or UE may serve as a communication hub for transmitting an upload data stream (e.g., of pose, gaze and imagery data) from the XR wearable device to the remote server or edge server. In some implementations, the bridge device or UE may perform some of the processing of downloaded data while other processing is performed by a processor or processors within the XR wearable device.

XR wearable devices may project or display one or more graphics on lenses through which the user can also see the real-world, and as well as emit sounds from the frame or temples that the user can hear. The XR wearable devices may also allow the user to see through the lenses to the real world at the same time as graphics are displayed on the lenses. In many VR/AR/MR/XR applications, the augmented media (images, text and/or sounds) may be streamed to a bridge device or UE (e.g., a smart phone) and/or directly to XR wearable devices from an external server and/or an edge server. The audiovisual media that is presented on lenses of XR wearable devices may be generated at the XR wearable devices and/or UE, or generated, at least in part, at remote servers. The user experience may be delivered by a shared extended reality application that is hosted on one or more external servers and/or edge servers and on the user device.

Because VR/AR/MR/XR media are added to the user experience as a part of the real world, the generation and rendering of this media necessarily includes the need to consider real-time aspects, such as the user's gaze as well images of the real world as seen by the user. In order to appropriately align the VR/AR/MR/XR display graphics with the real world seen through the lenses, the XR wearable devices may monitor the pose, orientation, eye-direction, and movement of the user and transmit that information to an external server and/or edge server that is streaming VR/AR/MR/XR media content for rendering on the XR wearable devices. In some embodiments, the XR wearable devices may include one or more cameras that image the real world, with such imagery uploaded to the external server and/or edge server for use in identifying appropriate VR/AR/MR/XR media to be downloaded to the UE and/or XR wearable devices.

Likewise, virtual reality (VR) may utilize sensor data, pose information, and camera views of the user or from the viewpoint of the user in order to provide a completely virtual but interactive experience. The VR system may utilize bridge devices, edge servers, and other computing and wireless resources depending on the configuration. Further, cameras have become commonplace in computing devices and many computing devices are now powerful enough to perform the real-time image recognition required for user gesture recognition. Accordingly, a user interface adapted for VR, AR, or XR devices may be usable in other contexts as well and may provide input options for the handicapped. Therefore, while example implementations may be explained herein for a user input interface for AR devices, the input components and processing of the input interface disclosed herein may be implemented in any computing device that can connect to a keyboard and camera.

In some AR or VR applications, users may use a physical keyboard for providing commands and other inputs to the application. Because most computer users do not need to look at a keyboard to type, such AR or VR applications need not show the keyboard in the GUI or may block the user's view of the keyboard when the user's head is not looking down. However, when the user needs to access a mouse as part of the application, this can pose a problem for the user and the mouse is likely not in a fixed location with respect to the keyboard keys. Thus, a user may need to look for the mouse or try to find the mouse blindly by move a hand around searching for it. This can interrupt the user's engagement in the application, and thus compromise the user experience.

One solution to this problem is to provide non-physical input methods, such as virtual mouse functionality, by imaging the user's hand movements and finger and hand orientations. Conventional virtual mouse methods recognizing user commands, text input, or enabling selections in a GUI involve recognizing predefined gestures from the user, button presses, or device movement (e.g., acceleration sensor, tilt sensor, attached mouse, attached joystick). In some AR or VR devices, eye movement may used to communicate commands to the device.

Conventional non-physical input methods have inherent deficiencies. For example, gestures, eye movement, and device tilting/acceleration can be clumsy, slow, and tiring to the user. Further, in VR/AR/MR/XR environments, users may have part of their vision obstructed by overlays and graphics, which makes reaching for input devices (e.g., a mouse) difficult. Hand gesture recognition is subject to missed and misinterpretations if the user does not perform the gesture just right or not the same way every time. In the case of a virtual mouse function, small movements of user's finger may be misinterpreted as an intended mouse click, and some finger movements may not be recognized as intended to be a mouse click, thus leading to user frustration.

The methods and computing devices implementing the methods of various embodiments address these deficiencies by enabling a physical keyboard to function as input keys for a virtual mouse thereby providing virtual mouse functionality that is natural and reliable for the user even in augmented reality environments.

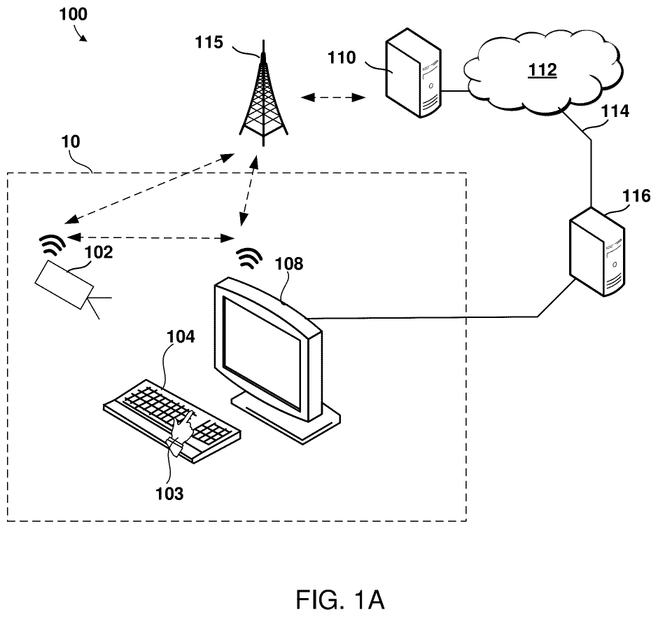

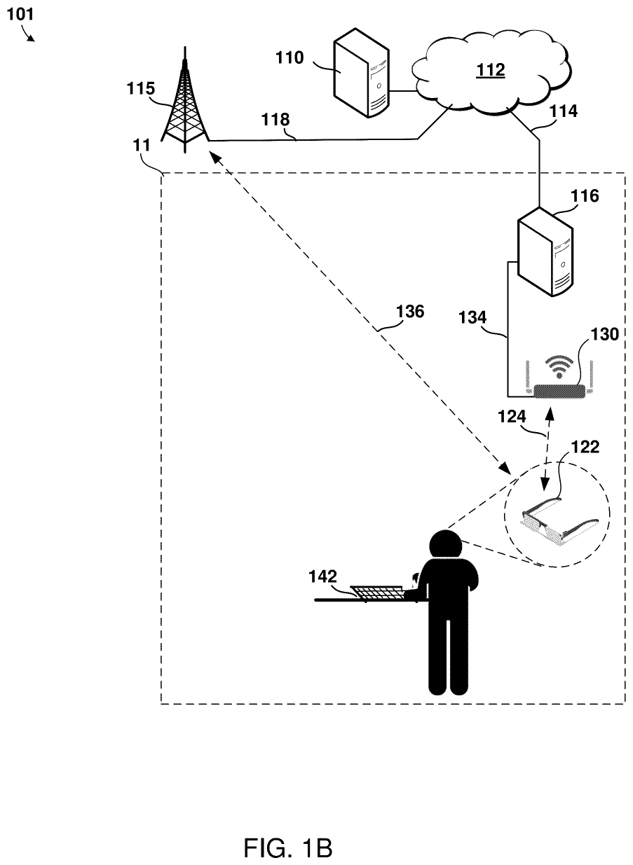

FIG. 1A is a system diagram illustrating an example system 100 including connections between various components of the input interface 10 and an external network. A computer 108 may include a wireless transceiver and display. The computer 108 may connect to the camera 102 (or other imaging device) and keyboard 104 via wireless communication or wired communication. The camera 102 may be arranged such that a field of view of the camera 102 includes a portion or all of keyboard 104. A user hand 103 (or hands) may be imaged by the camera 102 as well such that a relative position between the user hand 103 and the keyboard 104 may be determined.

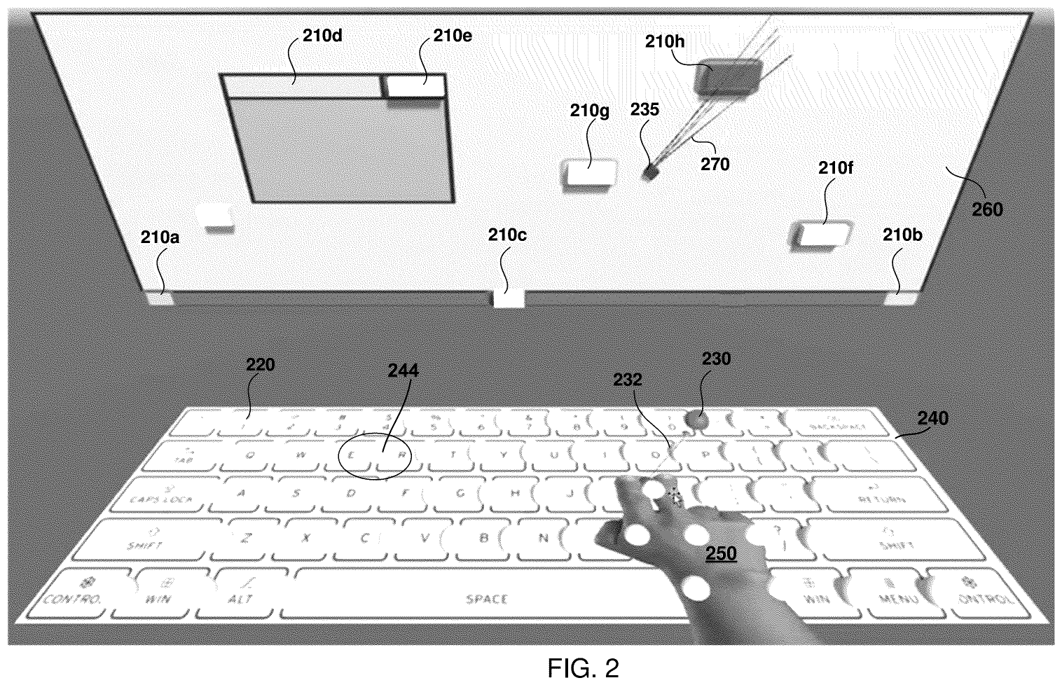

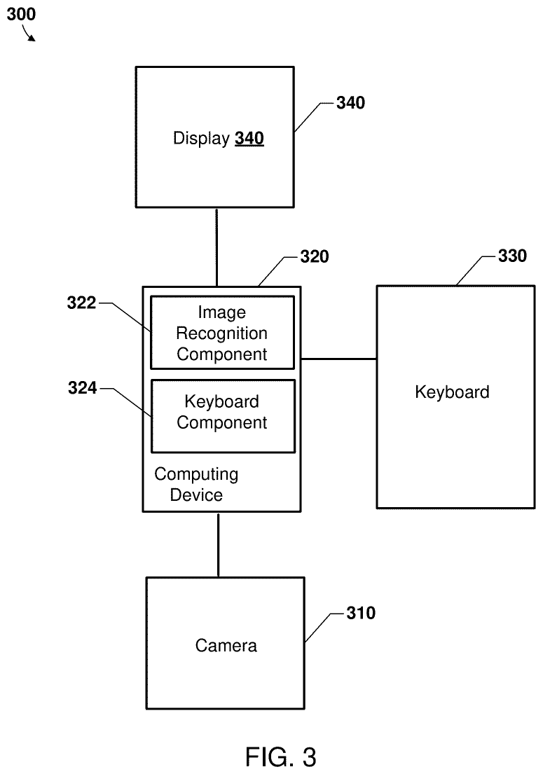

The camera 102 or the computer 108 may include image recognition software that when executed may identify a location of the user hand 103 and the keyboard 104 and may recognize gestures and movement of the user hand 103. To assist in accuracy, the camera 102 may be a stereoscopic camera, depth camera, or other specialized camera for object detection. The nature of the image recognition provided by the camera 102 or the computer 108 is described in more detail regarding FIG. 3. Together, the computer 108, camera 102, and keyboard 104 represent an example system for implementation of the user interface of various embodiments that does not involve an augmented reality environment. The user interface of FIG. 2 may be implemented in the system 100 or input interface components 10.

The computer 108 may connect to servers 116 (e.g., local area servers or edge servers) and may connect to wireless networks 115 (e.g., Wi-Fi, WiMAX, or 5G) for computing and data resources. The servers 116 may connect to communication network 112 (e.g., Internet) via connection 114 and further to remote servers or cloud servers 110. The wireless network 115 may connect to the remote servers 110 as well and may connect to the camera 102 and the computer 108. The other devices such as servers 116 and keyboard 104 may also connect with any of the other devices of system 100 via wireless network 115. The external resources (e.g., servers 116, 110) may be utilized to provide information or graphics for the user interface system 10.

In the embodiment illustrated in FIG. 1A, the camera 102 may track the user hand 103 to identify one or more gestures that are defined to signal a desire to switch from a keyboard entry mode for the user interface to a mouse entry mode for the user interface. In a keyboard entry mode, the user hand 103 may actuate one or more physical keys of the keyboard 104 to produce associated input from the keyboard 104. For example, the scan codes of the keyboard's keys may be translated into character or functional inputs according to the keyboard driver of the computer 108.

In a mouse entry mode, the user hand 103 may move over the keyboard 104 and be tracked by the camera 102 to produce movement of a cursor on a graphical user interface of computer 108. The switch to mouse entry mode may disable at least a portion of the keyboard 104 for character entry and key clicks from this disabled portion of the keyboard 104 may be converted to right and left mouse clicks according to a process described further below. The user's hand 103 may perform gestures to switch back to keyboard entry mode. An advantage of this input method is that the user's hand 103 on the keyboard can switch to a mouse entry mode without breaking the user's view from the screen of computer 108.

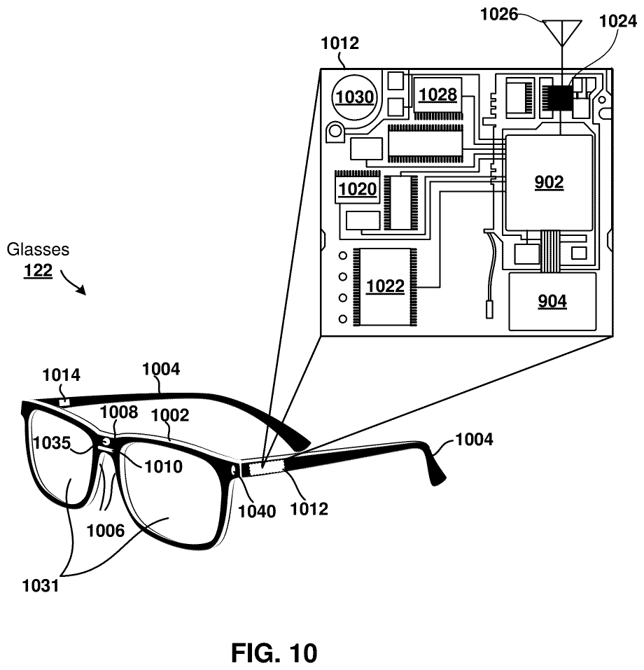

FIG. 1B is a system diagram illustrating an example system 101 including connections between various components of a local system 11 with an input interface and an external network. The user may be equipped with AR, XR, or VR glasses (e.g., glasses 122) which may communicate with access point 130. The glasses 122 may communicate with access point 130 via wireless connection 124 (e.g., Wi-Fi, Bluetooth, 5G) or a wired connection. The glasses 122 may connect to a wireless network 115 (e.g., cellular, WiMAX) via wireless link 136. The local system 11 may include a server 116 connected to the access point 130 via a wired link 134. The server 116 may provide low-latency computing resources to the glasses 122 including graphics rendering so as to save energy and processor resources on the glasses 122. The glasses 122 on the user may include one or more cameras as described in more detail regarding FIG. 10 and these cameras may have a field of view that includes the keyboard 142. Likewise, the glasses 122 may include one or more displays that provide a graphical user interface or graphical environment (e.g., video game) to the user. The keyboard 142 may be used together with gestures, recognizable by the glasses 122, to provide inputs to the glasses 122 and manipulate the graphics displayed on the glasses 122. The hand of the user of glasses 122 may operate the keyboard in keyboard entry mode and mouse entry mode as described above and in regard to FIG. 2. The cameras of the glasses 122 may operate as camera 102 of FIG. 1A and the glasses' computing resources along with local server 116 may operate as computer 108. In this way, the glasses 122 integrate a few of the components described in FIG. 1A and FIG. 2.

The local system 11 may connect to wireless network 115 via wireless line 136 and to communication network 112 (e.g., Internet) via communication line 114. Further, communication network 112 may connect to remote servers 110 (e.g., cloud resources) and to wireless network 115 via communication line 118. The glasses 122 may provide graphical data in a XR/VR/AR environment in conjunction with shared applications executed on servers 116 and 110 as well as on the glasses 122. Glasses 122 may include separate transceivers to communicate via communication links 136, 124. An example graphical user interface (GUI) for display in systems 100 or 101 is provided in FIG. 2 with more detail on the user input modes.

FIG. 2 is an illustration of an example system including a user interface including a keyboard 240 (e.g., keyboard 104, 142) and a display 260. The display 260 may include a number of clickable elements (e.g., buttons 210a, 210b, 210c, 210e, 210f, 210g, 210h) and application window 210d which is also clickable. Other aspects of the display 260 may be clickable (e.g., to reveal menus). The operating system (OS) that hosts the GUI of display 260 may identify or determine the clickable elements in the display. The OS may provide coordinates or designate areas that are clickable in real time. Likewise, a camera 102 may track one or more points on a user hand 250 in real time. A cursor 235 is also shown on the display 260. Movement of the user hand 250 may be tracked in real time and movement of the user hand 250 may be translated into movement of the cursor 235 when the user interface is in a mouse entry mode.

The user interface (UI) may operate in mouse entry mode by tracking the user hand 250 over the keyboard 240 and the movement of the cursor 235 may correspond to the hand movement. To enable the user to click with either a right or left mouse click using the keys of the keyboard, the UI together with the camera may predict a clickable element (e.g., 210h) that is predicted by the UI to be the target interface element to be clicked by the user. The UI may then select or identify a key pair (e.g., 230, 244) that will correspond to (may be predicted to correspond to) the end point of the cursor movement. That is, the UI may identify that the center of key pair 230 corresponds to the predicted target interface element 210h and may enable inputs from those two keys of the keyboard 240. The inputs from those two keys of key pair 230 may then be interpreted as right or left mouse clicks as the case may be.

In mouse entry mode, the UI may disable a portion of keyboard 240 and enable select keys (e.g., 220 or SPACE key) or key pairs (e.g., 230, 244) based on predictions from the graphical user interface in display 260. If a user's hand is predicted to move outside of the keyboard area in order to reach the predicted target UI element, then the UI may speed up or accelerate the movement of the cursor 235 so that the movement of the hand 250 to key pair 230 translates into more distance travelled on the display 260. Likewise, the UI may slow down or decelerate the cursor 235 while tracking the user hand 250 in real time to ensure that the pointer finger and index fingers land on a selected key pair at substantially the same time as the cursor arrives at the target element 210h. In other words, the UI may adjust the speed of cursor movement in real time to ensure that the two appropriate fingers of the user hand will land on a key pair that has been selected and activated.

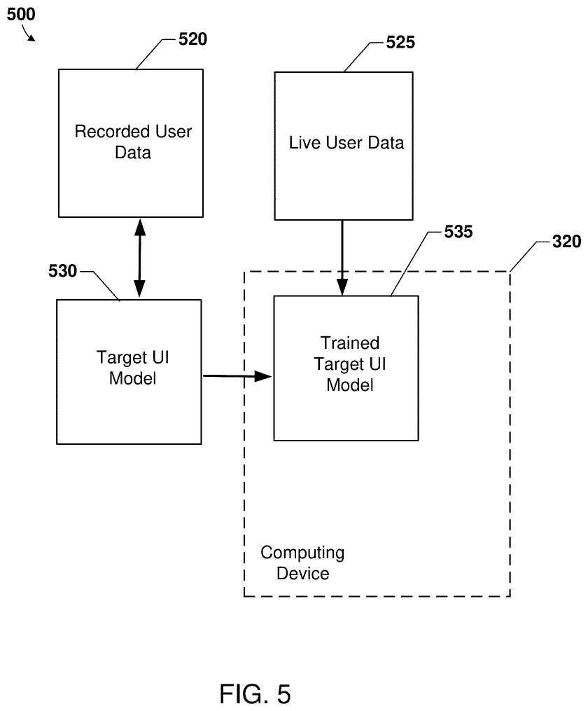

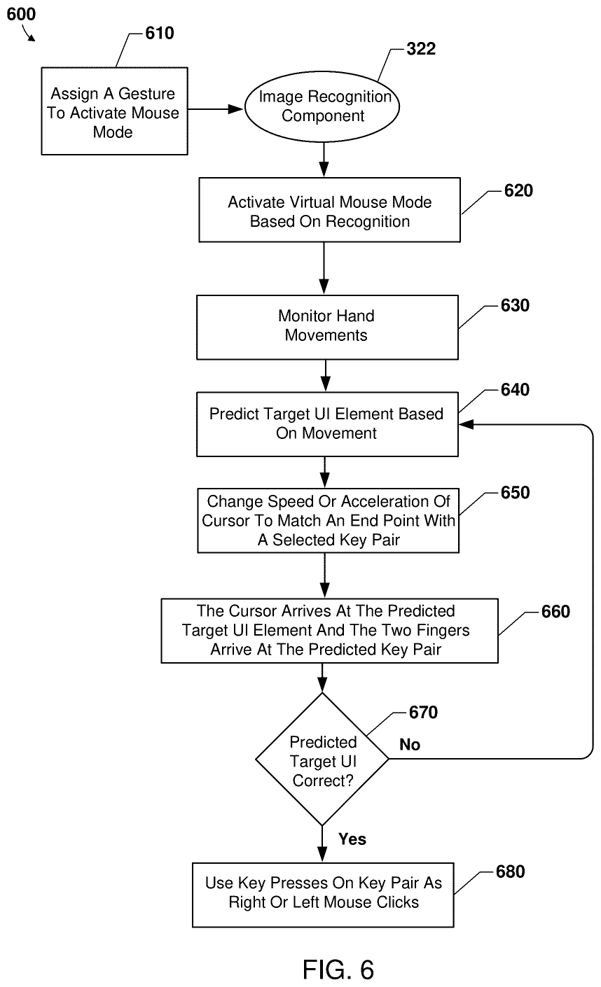

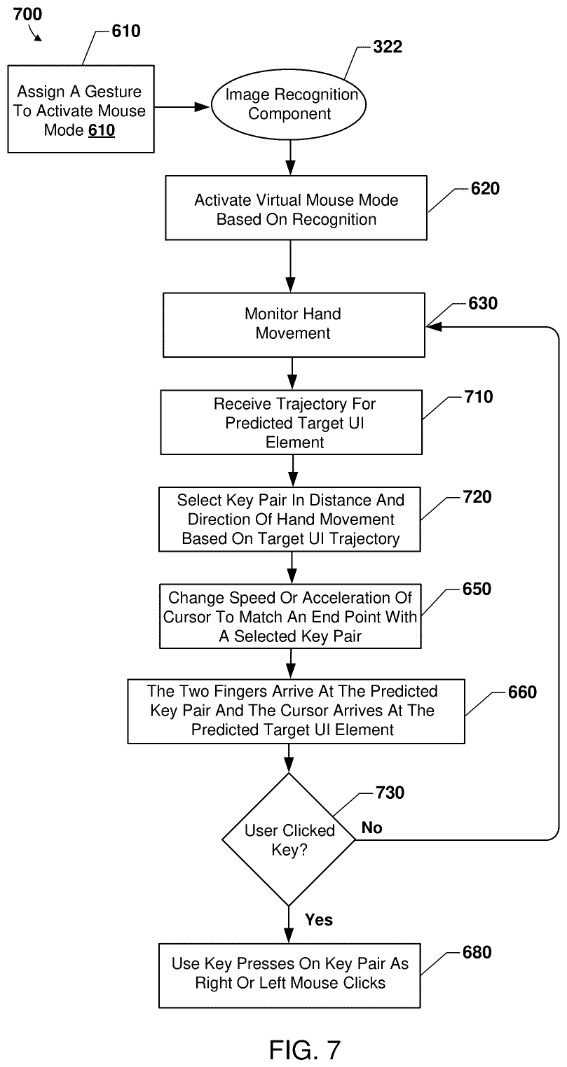

The keyboard 240 may be divided into parallel strips of key pairs as illustrated by the dots between keys. As the user hand 250 moves over the keyboard 240 in mouse entry mode, the camera 102 or glasses 122 may capture the movement of the user hand and may plot a trajectory 270 of the movement. The trajectory 270 of the cursor 235 (and, correspondingly, the user hand 250) may be used to predict the target UI element that the user intends to click (e.g., button 210h). The prediction calculated from the trajectory 270 may include a linear regression calculation or may involve a trained machine learning model as described regarding FIG. 5. The trajectory 270 may correspond to hand movement trajectory 232 or may be a linear approximation of such hand movement. If the user hand continues moving after the target UI element is reached or the user hand shifts direction, then the UI may update the predicted target UI element (e.g., to 210f) and may update the selected key pair on the keyboard that will be targeted for mouse button activation. Likewise, if the user's hand reaches the selected key pair and does not click or does not reach the selected key pair and then clicks, the UI may register this action as an errant prediction and update the prediction calculation or update the machine learning model. Further, after a user makes an unexpected action, the prediction process may restart as described in FIG. 6 and FIG. 7 so that the user can seamlessly progress to the intended UI element.

FIG. 3 is a system block diagram of a computing system suitable for implementing various embodiments. For example, the system 300 minus the keyboard 330 may be included in the glasses 122. The computing device 320 may be computer 108 or a processor of glasses 122. The computing device 320 may be a plurality of devices which may be local or remote (e.g., servers 116, 110). The computing device 320 may include one or more hardware interfaces (e.g., HDMI, USB, VGA) or transceivers to connect with the display 340, the keyboard 330, and the display 340. The computing device 320 may include an image recognition component 322 and a keyboard component 324.

The image recognition component 322 may receive images or video from camera 310 and may execute one or more software or hardware processes (e.g., OpenCV) to identify an area in the field of view defined by the keyboard 330, identify a user hand over the keyboard 330, and identify one or more gestures for controlling the computing device 320 or display 340. Upon a gesture of the user hand (e.g., hand 250), the image recognition component 322 may receive the image information containing the gesture from the camera 310 and may determine that a motion gesture or static gesture has been given by the user hand. The image recognition component 322 may then transmit one or more instructions to the keyboard component 324. For example, in response to a predefined finger positioning or a hand flip, the image recognition component 322 may identify the gesture and instruct the keyboard component 324 to switch to mouse entry mode or keyboard entry mode as the case may be.

In the mouse entry mode, the computing device 320 may control the image recognition component 322 to detect hand positioning in real time and adjust a position of a cursor (e.g., cursor 235) on display 340 based on the hand positioning. In keyboard entry mode, the image recognition component 322 may monitor the keyboard area to identify a gesture to activate mouse entry mode and, therefore, hand tracking. The image recognition component 322 or the keyboard component 324 may select the key pairs to be used for right and left mouse clicks as the hand moves across the keyboard 330. The image recognition component 322 may be configured to identify additional gestures or control signals relative to the keyboard 330 including movement of a thumb or other portion of the user hand along the SPACE key. For example, the identification of movement of a thumb laterally along the SPACE key may be translated or interpreted as a scrolling control signal or a zoom control signal of the virtual mouse controlled by the user's hand.

The keyboard component 324 may include one or more hardware drivers that translate keyboard hardware scan codes from the physical keyboard into characters and one or more hardware drivers that when switched to mouse entry mode translate the hardware scan codes as right or left mouse clicks. The keyboard component 324 may disable at least a portion of the keyboard 330 when in mouse entry mode so that scan codes are not propagated further into the computing device 320. The keyboard component 324 may selectively enable scan codes from identified key pairs that will function as mouse clicks as identified by the image recognition component 322. Accordingly, in keyboard entry mode, the keyboard component 324 operates to enable normal functioning of the physical keyboard for character or functional inputs to the user interface. The computing device 320 may generated display graphics (e.g., 260) for the display as described above based on the hardware inputs.

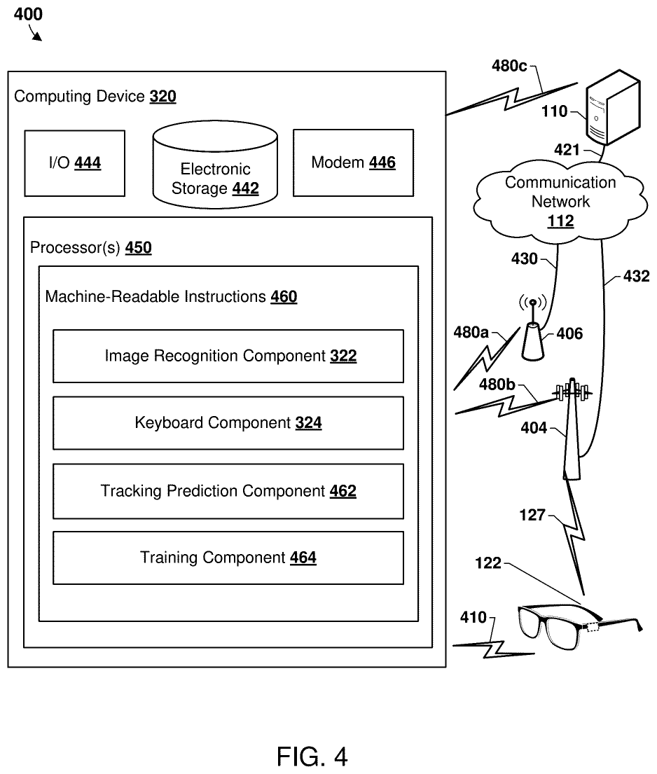

FIG. 4 is a system block diagram illustrating an example system suitable for implementing the user interface of various embodiments. With reference to FIGS. 1A-3, the system 400 may include glasses 122 configured to communicate with computing device 320 via a local wireless connection 410 (e.g., Wi-Fi, NFC, Bluetooth). The computing device 320 may also be embedded in glasses 122 and connect directly with glasses 122 and wirelessly as shown via glasses 122. The computing device 320 may also be configured to communicate with external resources (e.g., server 110) via a wireless connection 127, 480a, 480b, 480c to a wireless communication network 112, such as a cellular wireless communication network. Wireless connection 480a may be a radio link to picocell 406 which may connect via backhaul or midhaul 430 to communication network 112. Wireless connection 127 may be a radio link to gNB 404 which may connect via backhaul or midhaul 432 to communication network 112. The communication network 112 may connect to server 110 via link 421 (e.g., fiber) and a local server 116 may be co-located with gNB 404.

The computing device 320 may include one or more processors 450, electronic storage 442, I/O 444, a modem 446 (e.g., wireless transceiver), and other components. The computing device 320 may include communication lines, or ports to enable the exchange of information with a network and/or other computing platforms. Illustration of the computing device 320 in FIG. 4 is not intended to be limiting. The computing device 320 may include a plurality of hardware, software, and/or firmware components operating together to provide the functionality the computing device 320 in various embodiments.

Electronic storage 442 may include non-transitory storage media that electronically stores information. The electronic storage media of electronic storage 442 may include one or both of system storage that is provided integrally (i.e., substantially non-removable) with the computing device 320 and/or removable storage that is removably connectable to the computing device 320 via, for example, a port (e.g., a universal serial bus (USB) port, a firewire port, etc.) or a drive (e.g., a disk drive, etc.). Electronic storage 442 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 442 may include one or more virtual storage resources (e.g., cloud storage, a virtual private network, and/or other virtual storage resources). Electronic storage 442 may store software algorithms, information determined by processor(s) 450, information received from the computing device 320 or glasses 122, information received from the server 115, external resources (e.g., server 110), and/or other information that enables the computing device 320 to function as described herein.

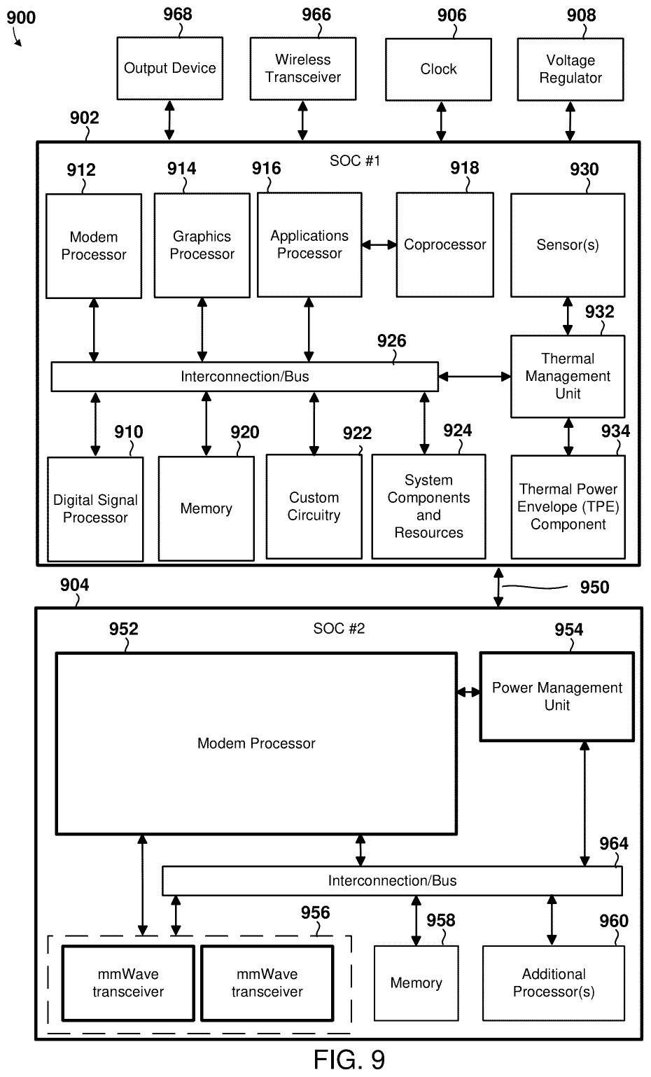

Processor(s) 450 may include one of more local processors (as described with respect to FIGS. 9, 10, and 11), which may be configured to provide information processing capabilities in the computing device 320 (or glasses 122). As such, processor(s) 450 may include one or more of a digital processor, an analog processor, a digital circuit designed to process information, an analog circuit designed to process information, a state machine, and/or other mechanisms for electronically processing information. Although processor(s) 450 is shown in FIG. 4 as a single entity, this is for illustrative purposes only. In some embodiments, processor(s) 450 may include a plurality of processing units. These processing units may be physically located within the same device, or processor(s) 450 may represent processing functionality of a plurality of devices operating in coordination.

The computing device 320 may be configured by machine-readable instructions 460, which may include one or more instruction modules. The instruction modules may include computer program components. In particular, the instruction modules may include one or more of an image recognition component 322, a keyboard component 324, a tracking prediction component 462, a training component 464, and/or other instruction modules. Together these components (e.g., 322, 324, 462, 464) of computing device 320 may provide an augmented reality experience via glasses 122 with a physical keyboard and virtual mouse as inputs.

The image recognition component 322 may connect to one or more cameras (e.g., camera 102) to capture the keyboard and hand movements in the vicinity of the keyboard. The image recognition component 322 may be configured, trained, or programmed to detect one or more gestures of the user's hand including static poses of the hand (e.g., peace sign) and movements of the hand (e.g., hand flip). Since a user's hand may take many different positions when typing in keyboard entry mode without any intention of triggering a switch to mouse entry mode, the gesture may be unique enough that it will not be triggered accidentally (e.g., hand flip). The user may be trained to perform a specific gesture until the image recognition component 322 reaches a success rate over 90%, for example. The image recognition component 322 may be trained to recognize a gesture provided by the user and may require repetition of the gesture until recognition reaches a success rate over 90%, for example.

The computing device 320 may be programmed by machine-readable instructions 460 to spawn a virtual mouse upon detection of a gesture as described herein. The virtual mouse may be virtually positioned underneath the hand of the user such that movement of the hand over the keyboard (e.g., 330) may move the virtual position of the virtual mouse and, thereby, may move a cursor controlled by the mouse. The virtual mouse may or may not be shown to the user in a virtual reality (VR) or augmented reality (AR/XR) environment. Advantageously, the user need not be shown the mouse or find the mouse since the virtual mouse will spawn at the position of a hand that makes the gesture and the activated keys for clicking will be activated below the hand as it moves. The user's hand representing the virtual mouse may be tracked by the image recognition component 322 and may be restricted to use only within the area of the keyboard (to ensure click availability). The image recognition component 322 may track the user's hand outside of the keyboard but may disable (halt transmission of) the signals from the virtual mouse of the computing device 320 for movement of the cursor of the virtual mouse. In other words, the image recognition component 322 may track the user's hand to provide positions and trajectories to the computing device 320 (or instructions thereon) for conversion into movement of the cursor (e.g., 235) of the virtual mouse.

As a non-limiting example, the processor(s) 450 of the computing device 320 may receive image or video data directly from cameras or image sensors on the glasses 122, use modem 446 to receive the data, and/or use one or more transceivers (e.g., 966, 1024) for detecting available wireless connections (e.g., Wi-Fi, Bluetooth, cellular, etc.) and obtaining the image data of the keyboard and hand(s). Likewise, the processor(s) 450 of the computing device 320 may transmit one or more graphics or images to a display (e.g., glasses 122, display 260) via modem 446, via transceivers (e.g., 966, 1024), or directly via wired connections.

The keyboard component 324 may include one or more drivers for interpreting binary or electrical signals from the keyboard (e.g., 330) and may convert these signals to characters or function control when a keyboard entry mode is active and convert these signals to right or left mouse clicks. The keyboard component 324 may receive information or instructions from the image recognition component 322 including instructions to switch an input mode and instructions to scroll when in mouse entry mode. The keyboard component 324 may disable a portion or all of the keyboard for character entry or function entry upon receiving a signal to switch to mouse entry mode.

As a non-limiting example, the processor(s) 450 of the computing device 320 may interpret, on the processors 450, signals from the physical/hardware keyboard, and/or use one or more transceivers (e.g., modem 446) to provide an interface to a connected device (e.g., glasses 122). The glasses 122 may connect to the computing device 320 via connection 410 and the computing device 320 may operate as a keyboard and virtual mouse combination for user interface manipulation in the user environment provided by the glasses 122.

The tracking prediction component 462 may receive inputs from the image recognition component 322 and/or directly from the camera(s) (e.g., 102). The tracking prediction component 462 may calculate trajectories for the hand (e.g., 232), may predict a target UI element (e.g., 210h) in the GUI, and may predict, based on the hand trajectory and the target UI element, a landing position of the hand upon reaching the target UI element. The tracking prediction component 462 may generate control instructions for controlling the speed or acceleration of the cursor of the virtual mouse of the computing device 320. The control instructions may be based on the predicted landing position of the hand and the target UI element. For example, if the tracking prediction component 462 determines that the landing position of the hand will fall outside the keyboard area, the tracking prediction component 462 may adjust the speed of the cursor movement relative to hand movement so that the user hand has a predicted trajectory end point within the keyboard area or on acceptable keys (e.g., not a wide key). The tracking prediction component 462 may determine a prediction error has occurred if a predicted action does not take place or the user continues moving after reaching a predicted end point. Correction of this error is described in more detail in FIG. 6 and FIG. 7.

As a non-limiting example, the processor(s) 450 of the computing device 320 may calculate the trajectories, timings, linear approximations, and other estimations of hand movement performed by the tracking prediction component 462. As a non-limiting example, the processor(s) 450 of the computing device 320 may calculate the trajectories, timings, linear approximations, and other estimations of cursor movement performed by the tracking prediction component 462. The modem 446 of the computing device 320 may transmit one or more cursor control instructions to a GUI (e.g., on display 260 or glasses 122).

The training component 464 of computing device 320 may receive information regarding a user identity, a user's hand movements, user's GUI usage, user's clicks, positions of clickable object, and a GUI layout. The training component 464 may include one or more machine readable instructions 460 that when executed cause processors 450 to generate a trained cursor/hand prediction model. The training process is described in more detail regarding FIG. 5. The trained model may be a recurrent neural network (RNN), a convolutional neural network (CNN), regression model, a decision tree model, nearest-neighbor model, or other estimator.

As a non-limiting example, the processor(s) 450 of the computing device 320 may execute the training component 464 on the processors, and/or use modem 446 to connect to displays or cameras. The processor(s) 450 of the computing device 320 may execute the training component 464 as a process that improves the model in real time (or with a defined time lag) based on user inputs, corrections, and validated predictions (e.g., clicked target UI element). The training component 464 may be executed on separate processors (e.g., remote server 116) based on stored user data as described regarding FIG. 5 to train the model or the training component 464 may be trained on the computing device 320.

FIG. 5 is a component block diagram of an example training process 500 suitable for use with various embodiments. With reference to FIGS. 1A-5, the training process 500 for a prediction model for predicting cursor/hand trajectories and end points may have one or more stages. In a first stage, recorded user data 520 may be inputted to a target UI model 530 (e.g., a learning model or statistical function). Depending on the type of model, the target UI model 530 may select a portion of the recorded user data 520 and correlate predictors to outcomes in the recorded user data 520. The target UI model 530 may then select a portion of the recorded user data 520 and test the correlated predictors using previously unused outcomes from the recorded user data 520. The training process 500 may iterate and repeat this process of learning and testing using portions of the user data until the target UI model 530 has sufficient accuracy (e.g., 90%, 95%, 99%).

Once the target UI model 530 has been trained to correlate predictors to outcomes accurately, the target UI model 530 may be exported or installed in a computing device 320. The installed trained target UI model 535 may operate as the training component 464 and may receive live user data 525 from a camera, the GUI, the keyboard, and other components of the system (e.g., 100, 101). The target UI model 530 may predict trajectories and end points as trained and provide these predictions to the computing device 320 for use in controlling the GUI. The trained target UI model 535 may receive information that indicates one or more prior predicted outcomes were incorrect as a part of live user data 525. The trained target UI model 535 may incorporate this error information into the model via machine learning and/or updated correlations. For example, the trained target UI model 535 may be trained or configured to the movements and habits of a particular user of the computing device 320. The training process 500 may include a local training stage for training the trained target UI model 535 for the user and for training the user on how to use the user interface.

FIG. 6 is a flow diagram illustrating an example of operations, states and events of a process 600 involved in cursor movement in some embodiments. With reference to FIGS. 1A-6, the operations of the process 600 illustrated in blocks 610-680 may be performed by the computing device 320, such as computer 108, XR wearable devices 122, or one or more components thereof (e.g., machine readable instructions 460 executed in a processor 450).

In block 610, the image recognition component 322 may be configured with information useful for recognizing a gesture by which a user can activate the virtual mouse mode. This gesture (e.g., hand motion or position) may be assigned by training the computer vision model of the image recognition component 322 or may be selected by a user.

In block 620, the image recognition component 322 may monitor user inputs and gestures, such as hand gestures, to recognize when the user is requesting activation of the virtual mouse operating mode. In response to recognizing such a user input or gesture, the image recognition component 322 generate an instruction to activate virtual mouse mode based on recognition of the gesture. In response to this command, the computing device 320 may activate the virtual mouse mode in block 620.

In block 630, the computing device 320 may monitor hand movements based on sensor (e.g., camera) inputs monitoring the user's hand. Once virtual mouse mode is activated, the image recognition component 322 may begin tracking the location of the user's hand and correlating hand movements to movement of a cursor presented in the GUI display. When the user interface is in keyboard mode (or not in virtual mouse mode), hand movement over the keyboard may be ignored. In virtual mouse mode, the computing device 320 may interpret hand movements as moving the virtual mouse and move the cursor in the GUI accordingly.

In block 640, the computing device 320 may predict a target UI element among the icons displayed in the GUI based on the movement of the hand tracked by the image recognition component 322. This may be accomplished by identifying a direction of movement of the cursor based on the user's hand motions and identify one or more icons on or near the direction of movement. Predicting the target UI element may also involve identifying icons displayed in the GUI that are currently active (i.e., available for user selection) or related to a current event or activity within a software application in which the user is engaged. Combining the direction of cursor movement relevant to displayed icons in the GUI and icons most related to current actions or events in the current software application may enable the computing device 320 to identify which of several displayed icons that the user is likely going to click on.

In 650, the computing device 320 may adjust the speed or acceleration of the cursor with respect to the user's hand movements so as to match a predicted end position of the user's hand when the cursor touches the target UI element hand movement with a selected key pair. If the computing device 320 calculates that the predicted end point of the hand upon reaching the target UI element will position the user's fingers over the selected keys of the keyboard, the adjustments of speed or acceleration in block 650 may be minimal. As described above, the adjustments of speed and acceleration of the cursor with respect to hand movements in block 650 are performed so that when the cursor touches the target UI element, the user's fingers are positioned over selected keys in the keyboard.

In block 660, the cursor arrives at the predicted target UI element and the two fingers arrive at the predicted key pair.

In determination block 670, the computing device 320 and/or image recognition component 322 may determine whether the predicted target UI element was correct such as by checking whether the user pressed one of the selected keys or continued moving.

If the user does not press a key or continues to move a hand, indicating that the predicted UI element may not have been correct, the computing device 320 reperform operations for predicting a target UI element based on the movement in block 640.

If the user then presses a key under one of the user's fingers, indicating that the predicted UI element may was correct, the computing device 320 may interpret the key press or presses on the key pair as right or left mouse clicks in block 680.

The process 600 may be performed continuously as long as the computing device 320 is in the virtual mouse operating mode to monitor hand movements and move the cursor in the GUI accordingly.

FIG. 7 is a flow diagram illustrating an example of operations and events of a process 700 involved in click targeting in some embodiments. With reference to FIGS. 1A-7, the operations and events in blocks 610-630 of the process 600 may be performed or occur as described. The operations of the process 700 may be performed by the computing device 320, computer 108, glasses 122, or one or more components thereof (e.g., machine readable instructions 460, processor(s) 450).

In block 710, the process may receive or determine a trajectory for the cursor to reach the predicted UI element.

In block 720, the process may select a key pair in a distance and direction of the hand movement based on the target UI trajectory. The hand movement trajectory may be different from the target UI trajectory. The computing device 320 may select a key pair, in block 720, and the computing device 320 or a component thereof may adjust the speed of the cursor accordingly in block 650 as described.

In block 660, the two fingers arrive at the predicted key pair and the cursor arrives at the predicted target UI element.

In block 730, the process 700 determines whether the user clicked a key on the keyboard (e.g., one of the key pair). If not, computing device 320 may perform the operations in block 630 to monitor hand movements that indicate a different target element or direction and continue the process 700.

If the user presses one of the selected keys in block 730, the computing device 320 may interpret the key presses on key pair as right or left mouse clicks in block 680. A portion of the keyboard (e.g., key pair) may operate as mouse buttons and another portion of the keyboard may operate for function or character entry (e.g., SHIFT+LEFT Mouse Click).

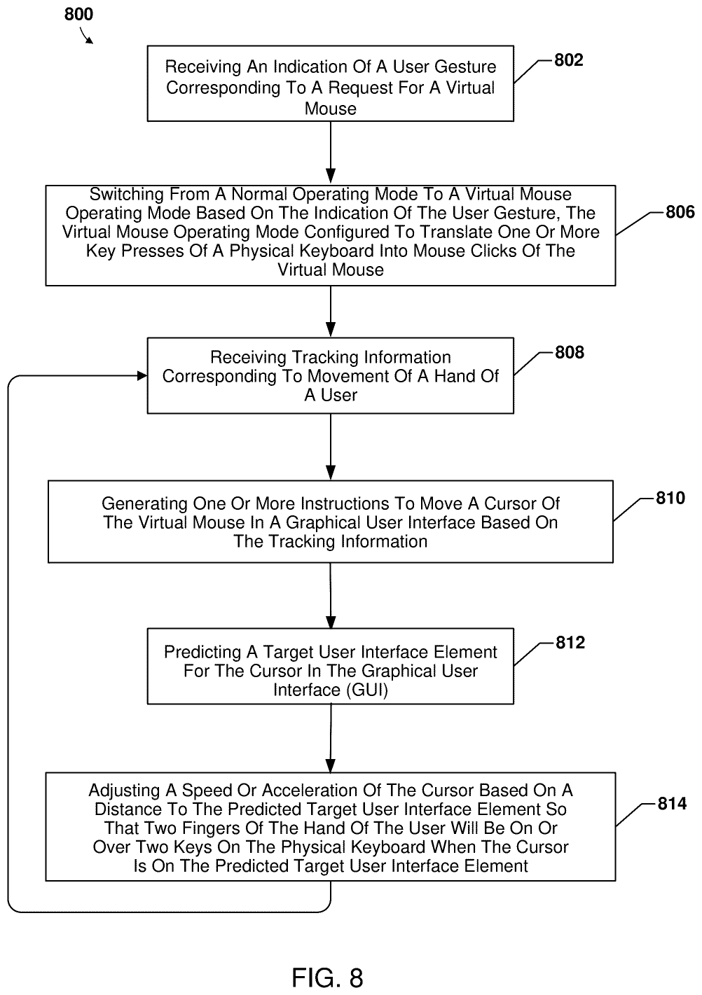

FIG. 8 is a flow diagram illustrating a method 800 according to some embodiments. With reference to FIG. 1A-8, the operations of the method 800 may be performed by a computing device 320, such as by a processor (e.g., 450, 902, 904) coupled to memory (e.g., 920). For ease of reference the method 800 is described as performed by a processor, which may be a processor of the computing device, a keyboard, a GUI interface, XR or AR goggles, and other processor-equipped components of or coupled to the computing device.

In block 802, the processor may perform operations including receiving an indication of a user gesture corresponding to a request for a virtual mouse. Means for performing the operations of block 802 may include a processor (e.g., 450, 902, 904) coupled to memory (e.g., 920) or at a remote source, such as a remote system or external resources using a transceiver (e.g., 966, 1024) and related components.

In block 804, the processor may perform operations including switching from a normal operating mode (e.g., keyboard entry mode) to a virtual mouse operating mode (e.g., mouse entry mode) based on the indication of the user gesture, the virtual mouse operating mode may be configured to translate one or more key presses of a physical keyboard into mouse clicks of the virtual mouse. Means for performing the operations of block 804 may include a processor (e.g., 450, 902, 904) coupled to memory (e.g., 920) or at a remote source, such as a remote system or external resources using a transceiver (e.g., 966, 1024) and related components.

In block 806, the processor may perform operations including receiving tracking information corresponding to movement of a hand of a user. Means for performing the operations of block 806 may include a processor (e.g., 450, 902, 904) coupled to memory (e.g., 920) or at a remote source, such as a remote system or external resources using a transceiver (e.g., 966, 1024) and related components.

In block 808, the processor may perform operations including generating one or more instructions to move a cursor of the virtual mouse in a graphical user interface based on the tracking information. Such instructions may be provided to a GUI interface in a manner that enables the GUI interface (or display) to present the cursor in locations and with movements correlated to user hand movements. Means for performing the operations of block 808 may include a processor (e.g., 450, 902, 904) coupled to memory (e.g., 920) or at a remote source, such as a remote system or external resources using a transceiver (e.g., 966, 1024) and related components.

In block 810, the processor may perform operations including predicting a target user interface element for the cursor in the graphical user interface (GUI). Means for performing the operations of block 810 may include a processor (e.g., 450, 902, 904) coupled to memory (e.g., 920) or at a remote source, such as a remote system or external resources using a transceiver (e.g., 966, 1024) and related components.

In block 812, the processor may perform operations including adjusting a speed or acceleration of the cursor based on a distance to the predicted target user interface element so that two fingers of the hand of the user will be on or over two keys on the physical keyboard when the cursor is on the predicted target user interface element. Means for performing the operations of block 812 may include a processor (e.g., 450, 902, 904) coupled to memory (e.g., 920) or at a remote source, such as a remote system or external resources using a transceiver (e.g., 966, 1024) and related components.

The operations in blocks 808-814 may be continuously or periodically performed so long as the computing device remains in the virtual mouse operating mode. After returning to a normal operating mode, the processor may monitor images of the user's hands or key presses to receive the next indication of the user requesting the virtual mouse operating mode.

FIG. 9 is a component block diagram illustrating an example computing and wireless modem system 900 suitable for implementing any of the various embodiments. Various embodiments may be implemented on a number of single processor and multiprocessor computer systems, including a system-on-chip (SOC) or system in a package (SIP).

With reference to FIGS. 1A-9, the illustrated example computing system 900 (which may be a SIP in some embodiments) includes a two SOCs 902, 904 coupled to a clock 906, a voltage regulator 908, a wireless transceiver 966 configured to send and receive wireless communications via an antenna (not shown) to/from a UE (e.g., glasses 122) or a network device (e.g., 110, 116), and an output device 968. In some embodiments, the first SOC 902 may operate as central processing unit (CPU) of glasses 122 or computer 108 that carries out the instructions of software application programs by performing the arithmetic, logical, control and input/output (I/O) operations specified by the instructions. In some embodiments, the second SOC 904 may operate as a specialized processing unit. For example, the second SOC 904 may operate as a specialized 5G processing unit responsible for managing high volume, high speed (such as 5 Gbps, etc.), and/or very high frequency short wavelength (such as 28 GHz mmWave spectrum, etc.) communications.

The first SOC 902 may include a digital signal processor (DSP) 910, a modem processor 912, a graphics processor 914, an application processor 916, one or more coprocessors 918 (such as vector co-processor) connected to one or more of the processors, memory 920, custom circuitry 922, system components and resources 924, an interconnection bus module 926, one or more temperature sensors 930, a thermal management unit 932, and a thermal power envelope (TPE) component 934. The second SOC 904 may include a 5G modem processor 952, a power management unit 954, an interconnection bus module 964, a plurality of mmWave transceivers 956, memory 958, and various additional processors 960, such as an applications processor, packet processor, etc.

Each processor 910, 912, 914, 916, 918, 952, 960 may include one or more cores and one or more temperature sensors, and each processor or processor core may perform operations independent of the other processors or processor cores. For example, the first SOC 902 may include a processor that executes a first type of operating system (such as FreeBSD, LINUX, OS X, etc.) and a processor that executes a second type of operating system (such as MICROSOFT WINDOWS 10). In addition, any or all of the processors 910, 912, 914, 916, 918, 952, 960 may be included as part of a processor cluster architecture (such as a synchronous processor cluster architecture, an asynchronous or heterogeneous processor cluster architecture, etc.).

The first and second SOC 902, 904 may include various system components, resources and custom circuitry for managing sensor data, analog-to-digital conversions, wireless data transmissions, and for performing other specialized operations, such as decoding data packets and processing encoded audio and video signals for rendering in a web browser. For example, the system components and resources 924 of the first SOC 902 may include power amplifiers, voltage regulators, oscillators, phase-locked loops, peripheral bridges, data controllers, memory controllers, system controllers, access ports, timers, and other similar components used to support the processors and software clients running on a core device. The system components and resources 924 and/or custom circuitry 922 also may include circuitry to interface with peripheral devices, such as cameras, electronic displays, wireless communication devices, external memory chips, etc.

The first and second SOC 902, 904 may communicate via interconnection bus module 950. The various processors 910, 912, 914, 916, 918, may be interconnected to one or more memory elements 920, system components and resources 924, and custom circuitry 922, and a thermal management unit 932 via an interconnection bus module 926. Similarly, the processor 952 may be interconnected to the power management unit 954, the mmWave transceivers 956, memory 958, and various additional processors 960 via the interconnection bus module 964. The interconnection bus module 926, 950, 964 may include an array of reconfigurable logic gates and/or implement a bus architecture (such as CoreConnect, AMBA, etc.). Communications may be provided by advanced interconnects, such as high-performance networks-on chip (NoCs).

The first and/or second SOCs 902, 904 may further include an input/output module (not illustrated) for communicating with resources external to the SOC, such as a clock 906 and a voltage regulator 908. Resources external to the SOC (such as clock 906, voltage regulator 908) may be shared by two or more of the internal SOC processors or processor cores. In addition to the example SIP 900 discussed above, various embodiments may be implemented in a wide variety of computing systems, which may include a single processor, multiple processors, multicore processors, or any combination thereof.

The processors of the glasses 122 or computer 108 1100 may be any programmable microprocessor, microcomputer or multiple processor chip or chips that can be configured by software instructions (applications) to perform a variety of functions, including the functions of various embodiments. In some wireless devices, multiple processors may be provided, such as one processor within an SOC 904 dedicated to wireless communication functions and one processor within an SOC 902 dedicated to running other applications. Processor-executable instructions of software applications may be stored in the memory 920 before the executable instructions are accessed and loaded into the processor. The processors may include internal memory sufficient to store the executable instructions of the application software.

Various embodiments (including embodiments discussed above with reference to FIGS. 1A-9) may be implemented on a variety of wearable devices, an example of which is illustrated in FIG. 10 in the form of glasses 122. With reference to FIGS. 1A-10, the glasses 122 may operate like conventional eyeglasses, but with enhanced computer features and sensors, like a built-in camera 1035 and heads-up display or graphical features on or near the lenses 1031. Like any glasses, smart glasses may include a frame 1002 coupled to temples 1004 that fit alongside the head and behind the ears of a wearer. The frame 1002 holds the lenses 1031 in place before the wearer's eyes when nose pads 1006 on the bridge 1008 rest on the wearer's nose.

In some embodiments, glasses 122 may include an image rendering device 1014 (e.g., an image projector), which may be embedded in one or both temples 1004 of the frame 1002 and configured to project images onto the optical lenses 1031. In some embodiments, the image rendering device 1014 may include a light-emitting diode (LED) module, a light tunnel, a homogenizing lens, an optical display, a fold mirror, or other components well known projectors or head-mounted displays. In some embodiments (e.g., those in which the image rendering device 1014 is not included or used), the optical lenses 1031 may be, or may include, see-through or partially see-through electronic displays. In some embodiments, the optical lenses 1031 include image-producing elements, such as see-through Organic Light-Emitting Diode (OLED) display elements or liquid crystal on silicon (LCOS) display elements. In some embodiments, the optical lenses 1031 may include independent left-eye and right-eye display elements. In some embodiments, the optical lenses 1031 may include or operate as a light guide for delivering light from the display elements to the eyes of a wearer.

The glasses 122 may include a number of external sensors that may be configured to obtain information about wearer actions and external conditions that may be useful for sensing images, sounds, muscle motions and other phenomenon that may be useful for detecting when the wearer is interacting with a virtual user interface as described. In some embodiments, the glasses 122 may include a camera 1035 configured to image objects in front of the wearer in still images or a video stream, which may be transmitted to another computing device (e.g., server 110 or remote server 110) for analysis. Additionally, the glasses 122 may include a ranging sensor 1040. In some embodiments, the glasses 122 may include a microphone 1010 positioned and configured to record sounds in the vicinity of the wearer. In some embodiments, multiple microphones may be positioned in different locations on the frame 1002, such as on a distal end of the temples 1004 near the jaw, to record sounds made when a user taps a selecting object on a hand, and the like. In some embodiments, the glasses 122 may include pressure sensors, such on the nose pads 1006, configured to sense facial movements for calibrating distance measurements. In some embodiments, glasses 122 may include other sensors (e.g., a thermometer, heart rate monitor, body temperature sensor, pulse oximeter, etc.) for collecting information pertaining to environment and/or user conditions that may be useful for recognizing an interaction by a user with a virtual user interface. These sensors (e.g., ranging sensors 1040) or an inertial measurement unit (IMU) may provide measurements to image recognition component 322 in order to generate or compile pose information for the user and assist with image recognition.

The processing system 1012 may include processing and communication SOCs 902, 904 which may include one or more processors, one or more of which may be configured with processor-executable instructions to perform operations of various embodiments. The processing and communications SOC 902, 904 may be coupled to internal sensors 1020, internal memory 1022, and communication circuitry 1024 coupled one or more antenna 1026 for establishing a wireless data link with an external computing device (e.g., remote server 110), such as via a Bluetooth or Wi-Fi link. The processing and communication SOCs 902, 904 may also be coupled to sensor interface circuitry 1028 configured to control and received data from a camera(s) 1035, microphone(s) 1010, and other sensors positioned on the frame 1002.

The internal sensors 1020 may include an IMU that includes electronic gyroscopes, accelerometers, and a magnetic compass configured to measure movements and orientation of the wearer's head. The internal sensors 1020 may further include a magnetometer, an altimeter, an odometer, and an atmospheric pressure sensor, as well as other sensors useful for determining the orientation and motions of the glasses 122. Such sensors may be useful in various embodiments for detecting head motions (e.g., pose changes) that may be used to adjust distance measurements as described. The processing system 1012 may further include a power source such as a rechargeable battery 1030 coupled to the SOCs 902, 904 as well as the external sensors on the frame 1002.

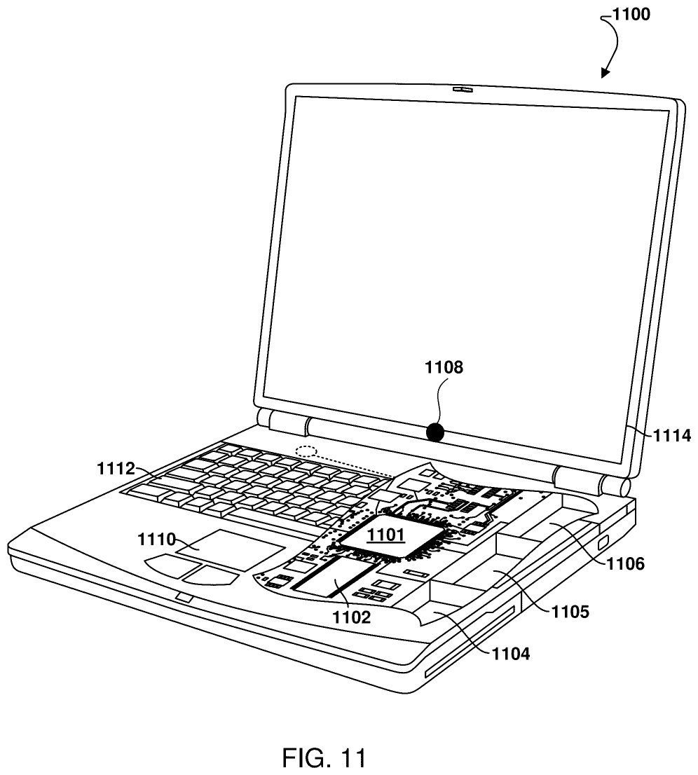

Various embodiments may be implemented in a variety of computing devices, such as a laptop computer 1100 as illustrated in FIG. 11. A laptop computer 1100 may include a processor 1101 coupled to volatile memory 1102, and a large capacity nonvolatile memory, such as a disk drive 1104. The laptop computer 1100 may also include an optical drive 1105 coupled to the processor 1106. The laptop computer 1100 may also include a number of connector ports or other network interfaces coupled to the processor 1101 for establishing data connections or receiving external devices (e.g., camera 102, glasses 122), via Universal Serial Bus (USB) or FireWire® connector sockets, or other network connection circuits for coupling the processor 1101 to a network (e.g., a communications network). In a notebook configuration, the computer housing may include the touchpad 1110, the keyboard 1112, and the display 1114 all coupled to the processor 1101. The computer housing may include a camera 1108 that has a field of view the covers keyboard 1112 and may operate as camera 102 to track the user's hand in some embodiments.

Various embodiments and implementations illustrated and described are provided merely as examples to illustrate various features of the claims. However, features shown and described with respect to any given embodiment or implementation are not necessarily limited to the associated embodiment or implementation and may be used or combined with other embodiments that are shown and described. Further, the claims are not intended to be limited by any one example embodiment or implementation. For example, one or more of the methods and operations of FIGS. 6-8 may be substituted for or combined with one or more operations of the methods and operations of FIGS. 6-8.

Implementation examples are described in the following paragraphs. While some of the following implementation examples are described in terms of example methods, further example implementations may include: the example methods discussed in the following paragraphs implemented by a UE including a processor configured with processor-executable instructions to perform operations of the methods of the following implementation examples; the example methods discussed in the following paragraphs implemented by a UE including means for performing functions of the methods of the following implementation examples; and the example methods discussed in the following paragraphs may be implemented as a non-transitory processor-readable storage medium having stored thereon processor-executable instructions configured to cause a processor of a UE to perform the operations of the methods of the following implementation examples.

Example 1. A method for receiving user inputs to a computing device, the method including: receiving tracking information corresponding to movement of a hand of a user while operating in a virtual mouse operating mode; generating one or more instructions to move a cursor of the virtual mouse in a graphical user interface (GUI) based on the tracking information; predicting a target user interface element for the cursor in the GUI; and adjusting a speed or acceleration of the cursor based on a distance to the predicted target user interface element so that two fingers of the hand of the user will be on or over two keys on the physical keyboard when the cursor is on the predicted target user interface element.

Example 2. The method of example 1, further including receiving an indication of a user gesture corresponding to a request for a virtual mouse; and switching from a normal operating mode to the virtual mouse operating mode in response to receiving the indication of the user gesture, the virtual mouse operating mode configured to translate one or more key presses of a physical keyboard into mouse clicks of the virtual mouse.

Example 3. The method of either of example 2, further including identifying the one or more key presses to translate based on the tracking information, in which switching from the normal operating mode to the virtual mouse operating mode disables at least the two keys of the physical keyboard for character input.

Example 4. The method of any of examples 1-3, further including: selecting a pair of keys on the physical keyboard at a corresponding distance from a position of the virtual mouse based on the tracking information and the predicted target user interface element, in which adjusting the speed or acceleration of the cursor is based on the distance to the predicted target user interface element and the corresponding distance between the pair of keys and the position of the virtual mouse so that two fingers of the hand of the user will be on or over the selected pair of keys on the physical keyboard when the cursor is on the predicted target user interface element.

Example 5. The method of any of methods 1-4, in which, in the virtual mouse operating mode, the one or more key presses of the physical keyboard is translated from a hardware key code of the physical keyboard into the mouse clicks at the computing device.

Example 6. The method of any of methods 1-5, in which predicting the target user interface element further comprises: receiving GUI information including one or more positions of clickable elements displayed in the GUI; calculating a vector for the cursor based on the tracking information; and identifying the predicted target user interface element based on the vector and the one or more positions of the clickable elements.

Example 7. The method of any of methods 1-6, in which movement of the cursor is confined to movement of the hand of the user over the physical keyboard.

Example 8. The method of any of methods 1-7, further including: mapping positions in a first area of the physical keyboard and a second area of the GUI so that the tracking information of the movement of the hand of the user over the first area relates to movement of the cursor in the GUI.

Example 9. The method of any of methods 1-8, in which one of a smart glove, a camera, or a user headset provides the tracking information, in which the tracking information relates to hand movements of the user in a predefined physical space.

Example 10. The method of any of methods 1-9, further including training a virtual mouse process to obtain the tracking information of a particular user in a training session by: generating one or more icon shapes in the GUI for the particular user to click; receiving tracking information corresponding to movement of a hand of the particular user; generating one or more instructions to move a cursor of the virtual mouse in a GUI based on the tracking information; predicting one of the icon shapes that the particular user is likely to click on in the GUI; adjusting the speed or acceleration of the cursor based on a distance to the predicted one of the icon shapes so that two fingers of the hand of the user will be on or over two selected keys on the physical keyboard when the cursor is on the predicted target user interface element; receiving key press information resulting from the particular user pressing two or more keys; and adjusting a parameter used in adjusting the speed or acceleration of the cursor in response to the received key press information indicating that the particular user pressed one or more keys different from the two selected keys on the physical keyboard.

As used in this application, the terms “component,” “module,” “system,” and the like are intended to include a computer-related entity, such as, but not limited to, hardware, firmware, a combination of hardware and software, software, or software in execution, which are configured to perform particular operations or functions. For example, a component may be, but is not limited to, a process running on a processor, a processor, an object, an executable, a thread of execution, a program, or a computer. By way of illustration, both an application running on a wireless device and the wireless device may be referred to as a component. One or more components may reside within a process or thread of execution and a component may be localized on one processor or core or distributed between two or more processors or cores. In addition, these components may execute from various non-transitory computer readable media having various instructions or data structures stored thereon. Components may communicate by way of local or remote processes, function or procedure calls, electronic signals, data packets, memory read/writes, and other known network, computer, processor, or process related communication methodologies.

A number of different cellular and mobile communication services and standards are available or contemplated in the future, all of which may implement and benefit from the various embodiments. Such services and standards include, e.g., third generation partnership project (3GPP), long term evolution (LTE) systems, third generation wireless mobile communication technology (3G), fourth generation wireless mobile communication technology (4G), fifth generation wireless mobile communication technology (5G) as well as later generation 3GPP technology, global system for mobile communications (GSM), universal mobile telecommunications system (UMTS), 3GSM, general packet radio service (GPRS), code division multiple access (CDMA) systems (e.g., cdmaOne, CDMA1020™), enhanced data rates for GSM evolution (EDGE), advanced mobile phone system (AMPS), digital AMPS (IS-136/TDMA), evolution-data optimized (EV-DO), digital enhanced cordless telecommunications (DECT), Worldwide Interoperability for Microwave Access (WiMAX), wireless local area network (WLAN), Wi-Fi Protected Access I & II (WPA, WPA2), and integrated digital enhanced network (iDEN). Each of these technologies involves, for example, the transmission and reception of voice, data, signaling, and/or content messages. It should be understood that any references to terminology and/or technical details related to an individual telecommunication standard or technology are for illustrative purposes only and are not intended to limit the scope of the claims to a particular communication system or technology unless specifically recited in the claim language.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are used to guide the reader through the description of the methods. Further, any reference to claim elements in the singular, for example, using the articles “a,” “an,” or “the” is not to be construed as limiting the element to the singular.

Various illustrative logical blocks, modules, components, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such embodiment decisions should not be interpreted as causing a departure from the scope of the claims.

The hardware used to implement various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver smart objects, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more embodiments, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in a processor-executable software module or processor-executable instructions, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage smart objects, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments described herein but is to be accorded the widest scope consistent with the following claims and the principles and novel features disclosed herein.

What is claimed is:

1. A method for receiving user inputs to a computing device, the method comprising:
receiving tracking information corresponding to movement of a hand of a user while operating in a virtual mouse operating mode;
generating one or more instructions to move a cursor of the virtual mouse in a graphical user interface (GUI) based on the tracking information;
predicting a target user interface element for the cursor in the GUI; and
adjusting a speed or acceleration of the cursor based on a distance to the predicted target user interface element so that two fingers of the hand of the user will be on or over two keys on the physical keyboard when the cursor is on the predicted target user interface element.

2. The method of claim 1, further comprising:
receiving an indication of a user gesture corresponding to a request for a virtual mouse; and
switching from a normal operating mode to the virtual mouse operating mode in response to receiving the indication of the user gesture, the virtual mouse operating mode configured to translate one or more key presses of a physical keyboard into mouse clicks of the virtual mouse.

3. The method of claim 2, further comprising:
identifying the one or more key presses to translate based on the tracking information,
wherein switching from the normal operating mode to the virtual mouse operating mode disables at least the two keys of the physical keyboard for character input.

4. The method of claim 1, further comprising:
selecting a pair of keys on the physical keyboard at a corresponding distance from a position of the virtual mouse based on the tracking information and the predicted target user interface element,
wherein adjusting the speed or acceleration of the cursor is based on the distance to the predicted target user interface element and the corresponding distance between the pair of keys and the position of the virtual mouse so that two fingers of the hand of the user will be on or over the selected pair of keys on the physical keyboard when the cursor is on the predicted target user interface element.

5. The method of claim 1, wherein, in the virtual mouse operating mode, the one or more key presses of the physical keyboard is translated from a hardware key code of the physical keyboard into the mouse clicks at the computing device.

6. The method of claim 1, wherein predicting the target user interface element further comprises:
receiving GUI information including one or more positions of clickable elements displayed in the GUI;
calculating a vector for the cursor based on the tracking information; and
identifying the predicted target user interface element based on the vector and the one or more positions of the clickable elements.

7. The method of claim 1, wherein movement of the cursor is confined to movement of the hand of the user over the physical keyboard.

8. The method of claim 1, further comprising:
mapping positions in a first area of the physical keyboard and a second area of the GUI so that the tracking information of the movement of the hand of the user over the first area relates to movement of the cursor in the GUI.

9. The method of claim 1, wherein one of a smart glove, a camera, or a user headset provides the tracking information, wherein the tracking information relates to hand movements of the user in a predefined physical space.

10. The method of claim 1, further comprising training a virtual mouse process to obtain the tracking information of a particular user in a training session by:
generating one or more icon shapes in the GUI for the particular user to click;
receiving tracking information corresponding to movement of a hand of the particular user;
generating one or more instructions to move a cursor of the virtual mouse in a GUI based on the tracking information;
predicting one of the icon shapes that the particular user is likely to click on in the GUI;
adjusting the speed or acceleration of the cursor based on a distance to the predicted one of the icon shapes so that two fingers of the hand of the user will be on or over two selected keys on the physical keyboard when the cursor is on the predicted target user interface element;
receiving key press information resulting from the particular user pressing two or more keys; and
adjusting a parameter used in adjusting the speed or acceleration of the cursor in response to the received key press information indicating that the particular user pressed one or more keys different from the two selected keys on the physical keyboard.

11. A computing device, comprising:
a physical keyboard;
a sensor configured to track movements of a hand of a user; and
a processor coupled to the keyboard and the sensor, the processor configured with processor-executable instructions to:
receive tracking information from the sensor corresponding to movement of a hand of a user while operating in a virtual mouse operating mode;
generate one or more instructions to move a cursor of the virtual mouse in a graphical user interface (GUI) based on the tracking information;
predict a target user interface element for the cursor in the GUI; and
adjust a speed or acceleration of the cursor based on a distance to the predicted target user interface element so that two fingers of the hand of the user will be on or over two keys on the physical keyboard when the cursor is on the predicted target user interface element.

12. The computing device of claim 11, wherein the processor is further configured with processor-executable instructions to:
receive, from the sensor, an indication of a user gesture corresponding to a request for a virtual mouse; and
switch from a normal operating mode to the virtual mouse operating mode in response to receiving the indication of the user gesture,
wherein in the virtual mouse operating mode the processor is configured to translate one or more key presses of the physical keyboard into mouse clicks of the virtual mouse.

13. The computing device of claim 12, wherein the processor is further configured with processor-executable instructions to:
identify the one or more key presses to translate based on the tracking information; and
disable at least the two keys of the physical keyboard for character input when switching from the normal operating mode to the virtual mouse operating mode.

14. The computing device of claim 11, wherein the processor is further configured with processor-executable instructions to:
select a pair of keys on the physical keyboard at a corresponding distance from a position of the virtual mouse based on the tracking information and the predicted target user interface element; and
adjust the speed or acceleration of the cursor based on the distance to the predicted target user interface element and the corresponding distance between the pair of keys and the position of the virtual mouse so that two fingers of the hand of the user will be on or over the selected pair of keys on the physical keyboard when the cursor is on the predicted target user interface element.

15. The computing device of claim 11, wherein the processor is further configured with processor-executable instructions to predict the target user interface element by:
receiving GUI information including one or more positions of clickable elements displayed in the GUI;
calculating a vector for the cursor based on the tracking information; and
identifying the predicted target user interface element based on the vector and the one or more positions of the clickable elements.

16. The computing device of claim 11, wherein movement of the cursor is confined to movement of the hand of the user over the physical keyboard.

17. The computing device of claim 11, wherein the processor is further configured with processor-executable instructions to:
map positions in a first area of the physical keyboard and a second area of the GUI so that the tracking information of the movement of the hand of the user over the first area relates to movement of the cursor in the GUI.

18. The computing device of claim 11, wherein the sensor is one of a smart glove, a camera, or a user headset provides the tracking information, wherein the tracking information relates to hand movements of the user in a predefined physical space.

19. The computing device of claim 11, wherein the processor is further configured with processor-executable instructions to train a virtual mouse process to obtain the tracking information of a particular user in a training session by:
generating one or more icon shapes in the GUI for the particular user to click;
receiving tracking information corresponding to movement of a hand of the particular user;
generating one or more instructions to move a cursor of the virtual mouse in a GUI based on the tracking information;
predicting one of the icon shapes that the particular user is likely to click on in the GUI;
adjusting the speed or acceleration of the cursor based on a distance to the predicted one of the icon shapes so that two fingers of the hand of the user will be on or over two selected keys on the physical keyboard when the cursor is on the predicted target user interface element;
receiving key press information resulting from the particular user pressing two or more keys; and
adjusting a parameter used in adjusting the speed or acceleration of the cursor in response to the received key press information indicating that the particular user pressed one or more keys different from the two selected keys on the physical keyboard.

20. A computing device, comprising:
means for receiving tracking information corresponding to movement of a hand of a user while operating in a virtual mouse operating mode;
means for generating one or more instructions to move a cursor of the virtual mouse in a graphical user interface (GUI) based on the tracking information;
means for predicting a target user interface element for the cursor in the GUI; and
means for adjusting a speed or acceleration of the cursor based on a distance to the predicted target user interface element so that two fingers of the hand of the user will be on or over two keys on the physical keyboard when the cursor is on the predicted target user interface element.

21. The computing device of claim 20, further comprising:
means for receiving an indication of a user gesture corresponding to a request for a virtual mouse; and
means for switching from a normal operating mode to the virtual mouse operating mode in response to receiving the indication of the user gesture, the virtual mouse operating mode configured to translate one or more key presses of a physical keyboard into mouse clicks of the virtual mouse.

22. The computing device of claim 21, further comprising:
means for identifying the one or more key presses to translate based on the tracking information,
wherein means for switching from the normal operating mode to the virtual mouse operating mode disables at least the two keys of the physical keyboard for character input.

23. The computing device of claim 1, further comprising:
means for selecting a pair of keys on the physical keyboard at a corresponding distance from a position of the virtual mouse based on the tracking information and the predicted target user interface element,
wherein means for adjusting the speed or acceleration of the cursor comprises means for based on the distance to the predicted target user interface element and the corresponding distance between the pair of keys and the position of the virtual mouse so that two fingers of the hand of the user will be on or over the selected pair of keys on the physical keyboard when the cursor is on the predicted target user interface element.

24. The computing device of claim 20, wherein means for predicting the target user interface element further comprises:
means for receiving GUI information including one or more positions of clickable elements displayed in the GUI;
means for calculating a vector for the cursor based on the tracking information; and
means for identifying the predicted target user interface element based on the vector and the one or more positions of the clickable elements.

25. The computing device of claim 20, wherein movement of the cursor is confined to movement of the hand of the user over the physical keyboard.

26. The computing device of claim 20, further comprising:
means for mapping positions in a first area of the physical keyboard and a second area of the GUI so that the tracking information of the movement of the hand of the user over the first area relates to movement of the cursor in the GUI.

27. The computing device of claim 20, wherein means for receiving tracking information corresponding to movement of the hand of the user is one of a smart glove, a camera, or a user headset, wherein the tracking information relates to hand movements of the user in a predefined physical space.

28. The computing device of claim 1, further comprising means for training a virtual mouse process to obtain the tracking information of a particular user in a training session comprising:
means for generating one or more icon shapes in the GUI for the particular user to click;
means for receiving tracking information corresponding to movement of a hand of the particular user;
means for generating one or more instructions to move a cursor of the virtual mouse in a GUI based on the tracking information;
means for predicting one of the icon shapes that the particular user is likely to click on in the GUI;
means for adjusting the speed or acceleration of the cursor based on a distance to the predicted one of the icon shapes so that two fingers of the hand of the user will be on or over two selected keys on the physical keyboard when the cursor is on the predicted target user interface element;
means for receiving key press information resulting from the particular user pressing two or more keys; and
means for adjusting a parameter used in adjusting the speed or acceleration of the cursor in response to the received key press information indicating that the particular user pressed one or more keys different from the two selected keys on the physical keyboard.

29. A non-transitory processor-readable medium having stored thereon processor-executable instructions configured to cause a processor of a computing device to perform operations comprising:
receiving tracking information corresponding to movement of a hand of a user while operating in a virtual mouse operating mode;
generating one or more instructions to move a cursor of the virtual mouse in a graphical user interface (GUI) based on the tracking information;
predicting a target user interface element for the cursor in the GUI; and
adjusting a speed or acceleration of the cursor based on a distance to the predicted target user interface element so that two fingers of the hand of the user will be on or over two keys on the physical keyboard when the cursor is on the predicted target user interface element.
